(19) United States
(12) Patent Application Publication
(10) Pub. No.: US 2025/0342706 A1
(43) Pub. Date: Nov. 6, 2025

(54) GENERATING SYNTHETIC CAPTIONS FOR TRAINING TEXT-TO-IMAGE GENERATIVE MODELS

(71) Applicant: Databricks, Inc., San Francisco, CA (US)

(72) Inventors: Aaron Kerem Gokaslan, New York City, NY (US); Cory Ryan Stephenson, Mountain View, CA (US)

(21) Appl. No.: 18/653,469

(22) Filed: May 2, 2024

(51) Int. Cl. G06V 20/70; G06T 3/40; G06V 10/774

(52) U.S. Cl. CPC G06V 20/70; G06T 3/40; G06V 10/7753

(57) ABSTRACT

A data processing service generates synthetic captions for uncaptioned images of a set of training data. The data processing service applies a pre-trained I2T model to the uncaptioned images, generating synthetic captions as output. The data processing service uses the training data to train a T2I model to produce images from text.

### TECHNICAL FIELD

The disclosed configuration relates generally to training machine learning models, and more particularly to generating synthetic captions for training data using a pretrained model.

### BACKGROUND

Text-to-image models generate images from text input. To train a text-to-image model, training data in the form of images paired with text captions is required. As such, text-to-image models are often trained on captioned datasets, which can include millions or billions of captioned images. While captioned datasets provide large numbers of captioned images and an element of convenience, there are instances where an entity would desire to train a text-to-image model with a dataset that includes uncaptioned images. For example, an existing captioned dataset may be insufficient or may not include images that the entity desires for training a text-to-image model. Additionally, it is often advantageous or necessary to train text-to-image models on datasets including custom images rather than on datasets including images from existing captioned datasets. As many image sets, custom or not, are large in size and largely uncaptioned, there exists a need to generate synthetic captions for uncaptioned images.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

Figure (FIG. 1 is a high-level block diagram of a system environment for a data processing service, in accordance with an embodiment.

FIG. 2 illustrates a block diagram of an architecture of a data storage system, in accordance with an embodiment.

FIG. 3 illustrates a block diagram of an architecture of a control layer, in accordance with an embodiment.

FIG. 4 illustrates a block diagram of an architecture of a cluster computing system of the data layer, in accordance with an embodiment.

FIG. 5 is a block diagram of an architecture of a driver node, in accordance with an embodiment.

FIGS. 6A-C illustrate an example of training a L2H model by generating synthetic captions for training data, in accordance with an embodiment.

FIG. 7 illustrates a method for training a text-to-image (T2I) model using training data with images and synthetic captions, in accordance with an embodiment.

FIG. 8 is an example machine to read and execute computer readable instructions, in accordance with an embodiment.

### DETAILED DESCRIPTION

A data processing service trains a low-to-high generative machine learning model using synthetic captions generated by a pretrained high-to-low machine learning model. A low-to-high (L2H) machine learning model is a generative model trained to map content of a low-dimensional (LD) data modality to a high-dimensional (HD) data modality. HD data is data that captures content with a significantly high number of features. For example, HD data may be an image with multiple pixels, or a video with multiple frames of images. LD data is data that captures the same content with a lower number of features. Namely, the LD data does not capture all the nuances and sensitivities of the HD data but rather captures some central or core summarization, description, or concepts of the content. For example, LD data may capture the content of an image with a text caption or capture the content of an audio clip with several frequencies.

One example of a low-to-high machine learning model may be a text-to-image (T2I) generative model. A T2I model refers to a large neural network trained on paired image-caption data. One family of T2I models is Stable Diffusion (SD). SD is a latent diffusion model that converts images in latent representations and back again using variational autoencoders and a convolutional neural network, such as a U-net. SD uses an iterative sampling procedure and trains the underlying U-net. The architecture of an SD model includes a text encoder, such as the Contrastive Language-Image Pre-training (CLIP) model. Versions of SD models may have on the order of hundreds of millions to billions of parameters as a part of their U-nets. Training a T2I model requires training data in the form of images paired with text captions. SD models, for example, are often trained on large-scale datasets, which can include millions or billions of captioned images.

A high-to-low (H2L) machine learning model maps HD data to LD data. A H2L model may be an image-to-text (I2T) model which may generate text describing or representing an image input into the model. One example of an I2T model is a BLIP-2 model. A BLIP-2 model is a visual language model that forms connections between images and text captions. BLIP-2 consists of three components: a pre-trained, fixed (i.e., frozen) visual encoder, a learned transformer network that converts the visual embeddings into a text prompt, and a frozen LLM that takes in the prompt. The LLM helps impart natural-language knowledge to the model, ensuring that the distribution of synthesized captions match patterns in English-natural language. The only trainable variables in the transformers are between the frozen visual encoder and frozen LLM layers. Like training an SD model, training a I2T model also requires training data in the form of images paired with text captions.

The data processing service generates synthetic captions for uncaptioned images for a set of training data. The data processing service applies a pre-trained I2T model to the uncaptioned images, generating synthetic captions as output. The data processing service uses the training data to train a T2I model to produce images from text. Note that while the process describe herein describes a data processing service generating text captions with an I2T model in order to train a T2I model, note that the reverse process may happen where the data processing service generates image captions with a T2I model in order to train an I2T model. Additionally, while a text-to-image and image-to-text model are referred to throughout the disclosure, the models may be generally low-to-high dimensionality or high-to-low dimensionality models. The described process may refer to generating synthetic captions of any one data type for any other type of data, such as audio captions for video data, image keyframes for video data, text captions for audio data, etc.

The figures depict various embodiments of the present configuration for purposes of illustration only. One skilled in the art will readily recognize from the following discussion that alternative embodiments of the structures and methods illustrated herein may be employed without departing from the principles of the configuration described herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

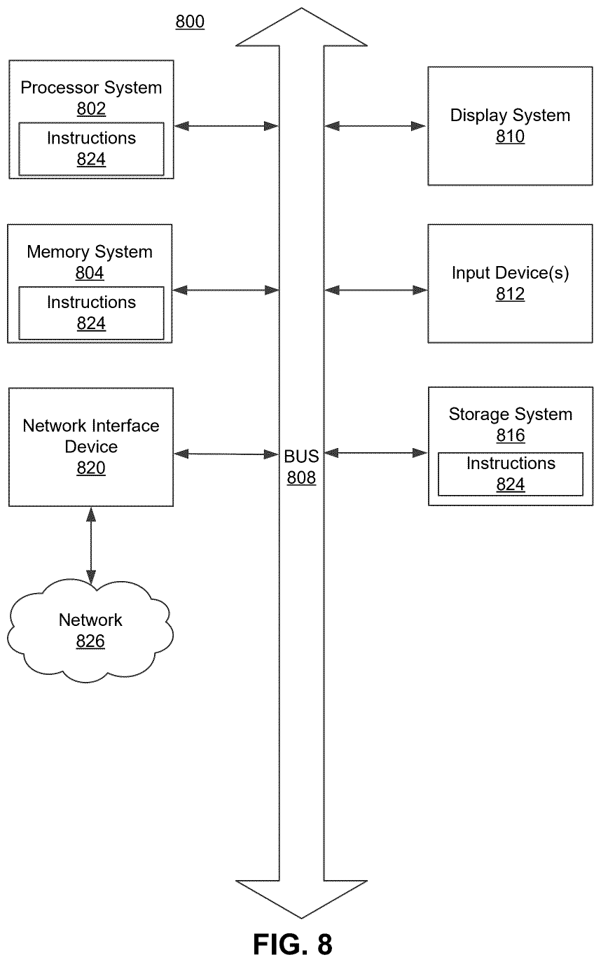

FIG. 1 is a high-level block diagram of a system environment 100 for a data processing service 102, in accordance with an embodiment. The system environment 100 shown by FIG. 1 includes one or more client devices 116A, 116B, a network 120, a data processing service 102, and a data storage system 110. In alternative configurations, different and/or additional components may be included in the system environment 100. The computing systems of the system environment 100 may include some or all of the components (systems (or subsystems)) of a computer system 800 as described with FIG. 8.

The data processing service 102 is a service for managing and coordinating data processing services (e.g., database services) to users of client devices 116. The data processing service 102 may manage one or more applications that users of client devices 116 can use to communicate with the data processing service 102. Through an application of the data processing service 102, the data processing service 102 may receive requests (e.g., database queries) from users of client devices 116 to perform one or more data processing functionalities on data stored, for example, in the data storage system 110. The requests may include query requests, analytics requests, or machine learning and artificial intelligence requests, and the like, on data stored by the data storage system 110. The data processing service 102 may provide responses to the requests to the users of the client devices 116 after they have been processed.

In one embodiment, as shown in the system environment 100 of FIG. 1, the data processing service 102 includes a control layer 106 and a data layer 108. The components of the data processing service 102 may be configured by one or more servers and/or a cloud infrastructure platform. In one embodiment, the control layer 106 receives data processing requests and coordinates with the data layer 108 to process the requests from client devices 116. The control layer 106 may schedule one or more jobs for a request or receive requests to execute one or more jobs from the user directly through a respective client device 116. The control layer 106 may distribute the jobs to components of the data layer 108 where the jobs are executed.

The control layer 106 is additionally capable of configuring the clusters in the data layer 108 that are used for executing the jobs. For example, a user of a client device 116 may submit a request to the control layer 106 to perform one or more queries and may specify that four clusters on the data layer 108 be activated to process the request with certain memory requirements. Responsive to receiving this information, the control layer 106 may send instructions to the data layer 108 to activate the requested number of clusters and configure the clusters according to the requested memory requirements.

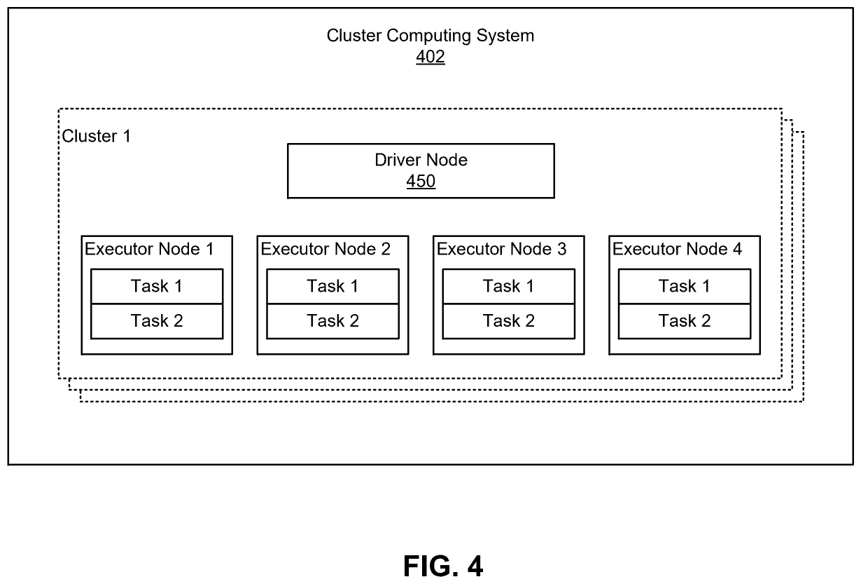

The data layer 108 includes multiple instances of clusters of computing resources that execute one or more jobs received from the control layer 106. Accordingly, the data layer 108 may include a cluster computing system for executing the jobs. An example of a cluster computing system is described in relation to FIG. 4. In one instance, the clusters of computing resources are virtual machines or virtual data centers configured on a cloud infrastructure platform. In one instance, the control layer 106 is configured as a multi-tenant system and the data layers 108 of different tenants are isolated from each other. In one instance, a serverless implementation of the data layer 108 may be configured as a multi-tenant system with strong virtual machine (VM) level tenant isolation between the different tenants of the data processing service 102. Each customer represents a tenant of a multi-tenant system and shares software applications and also resources such as databases of the multi-tenant system. Each tenant's data is isolated and remains invisible to other tenants. For example, a respective data layer instance can be implemented for a respective tenant. However, it is appreciated that in other embodiments, single tenant architectures may be used.

The data layer 108 thus may be accessed by, for example, a developer through an application of the control layer 106 to execute code developed by the developer. In one embodiment, a cluster in a data layer 108 may include multiple worker nodes that execute multiple jobs in parallel. Responsive to receiving a request, the data layer 108 divides the cluster computing job into a set of worker jobs, provides each of the worker jobs to a worker node, receives worker job results, stores job results, and the like. The data layer 108 may include resources not available to a developer on a local development system, such as powerful computing resources to process very large data sets. In this manner, when the data processing request can be divided into jobs that can be executed in parallel, the data processing request can be processed and handled more efficiently with shorter response and processing time.

In one embodiment, the data processing service 102 trains a low-to-high generative machine learning model using synthetic captions generated by a pretrained high-to-low machine learning model. A low-to-high (L2H) machine learning model is a generative model trained to map content of a low-dimensional (LD) data modality to a high-dimensional (HD) data modality. HD data is data that captures content with a significantly high number of features. For example, HD data may be an image with multiple pixels, or a video with multiple frames of images. LD data is data that captures the same content with a lower number of features. Namely, the LD data does not capture all the nuances and sensitivities of the HD data but rather captures some central or core summarization, description, or concepts of the content. For example, LD data may capture the content of an image with a text caption or capture the content of an audio clip with several frequencies.

One example of a low-to-high machine learning model may be a text-to-image (T2I) generative model. A T2I model refers to a large neural network trained on paired image-caption data. One family of T2I models is Stable Diffusion (SD). SD is a latent diffusion model that converts images in latent representations and back again using variational autoencoders and a convolutional neural network, such as a U-net. SD uses an iterative sampling procedure and trains the underlying U-net. The architecture of an SD model includes a text encoder, such as the Contrastive Language-Image Pre-training (CLIP) model. Versions of SD models may have on the order of hundreds of millions to billions of parameters as a part of their U-nets. Training a T2I model requires training data in the form of images paired with text captions. SD models, for example, are often trained on large-scale datasets, which can include millions or billions of captioned images.

A high-to-low (H2L) machine learning model maps HD data to LD data. A H2L model may be an image-to-text (I2T) model which may generate text describing or representing an image input into the model. One example of an I2T model is a BLIP-2 model. A BLIP-2 model is a visual language model that forms connections between images and text captions. BLIP-2 consists of three components: a pre-trained, fixed (i.e., frozen) visual encoder, a learned transformer network that converts the visual embeddings into a text prompt, and a frozen LLM that takes in the prompt. The LLM helps impart natural-language knowledge to the model, ensuring that the distribution of synthesized captions match patterns in English-natural language. The only trainable variables in the transformers are between the frozen visual encoder and frozen LLM layers. Like training an SD model, training a I2T model also requires training data in the form of images paired with text captions.

The data processing service 102 generates synthetic captions for uncaptioned images for a set of training data. The data processing service 102 applies a pre-trained I2T model to the uncaptioned images, generating synthetic captions as output. The data processing service 102 uses the training data to train a T2I model to produce images from text. Note that while the process describe herein describes a data processing service 102 generating text captions with an I2T model in order to train a T2I model, note that the reverse process may happen where the data processing service 102 generates image captions with a T2I model in order to train an I2T model. Additionally, while a text-to-image and image-to-text model are referred to throughout the disclosure, the models may be generally low-to-high dimensionality or high-to-low dimensionality models. The described process may refer to generating synthetic captions of any one data type for any other type of data, such as audio captions for video data, image keyframes for video data, text captions for audio data, etc.

The data storage system 110 includes a device (e.g., a disc drive, a hard drive, a semiconductor memory) used for storing database data (e.g., a stored data set, portion of a stored data set, data for executing a query). In one embodiment, the data storage system 110 includes a distributed storage system for storing data and may include a commercially provided distributed storage system service. Thus, the data storage system 110 may be managed by a separate entity than an entity that manages the data processing service 102 or the data management system 110 may be managed by the same entity that manages the data processing service 102.

The client devices 116 are computing devices that display information to users and communicates user actions to the systems of the system environment 100. While two client devices 116A, 116B are illustrated in FIG. 1, in practice many client devices 116 may communicate with the systems of the system environment 100. In one embodiment, client devices 116 of the system environment 100 may include some or all of the components (systems (or subsystems)) of a computer system 800 as described with FIG. 8.

In one embodiment, a client device 116 executes an application allowing a user of the client device 116 to interact with the various systems of the system environment 100 of FIG. 1. For example, a client device 116 can execute a browser application to enable interaction between the client device 116 and the data processing system 106 via the network 120. In another embodiment, the client device 116 interacts with the various systems of the system environment 100 through an application programming interface (API) running on a native operating system of the client device 116, such as IOS® or ANDROID™.

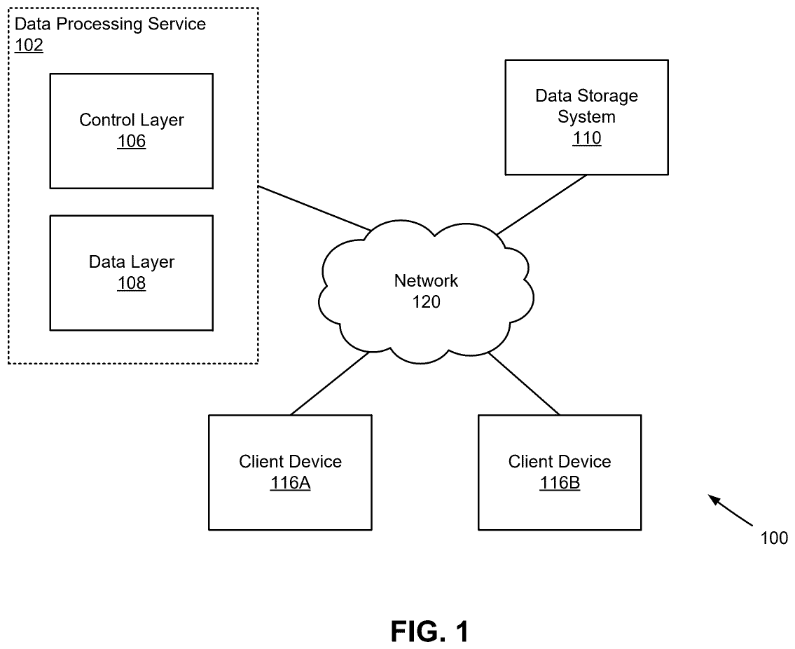

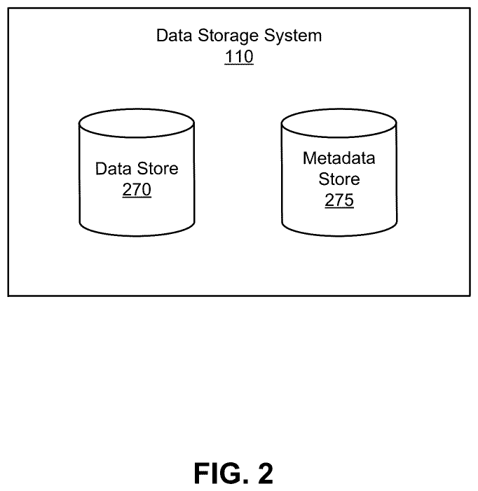

FIG. 2 is a block diagram of an architecture of a data storage system 108, in accordance with an embodiment. In one embodiment, the data storage system 108 includes a data ingestion module 250. The data storage system 108 also includes a data tables store 270 and a metadata store 275.

The data store 270 stores data associated with different tenants of the data processing service 102. In one embodiment, the data in data store 270 is stored in a format of a data table. A data table may include a plurality of records or instances, where each record may include values for one or more features. The records may span across multiple rows of the data table and the features may span across multiple columns of the data table. In other embodiments, the records may span across multiple columns and the features may span across multiple rows. For example, a data table associated with a security company may include a plurality of records each corresponding to a login instance of a respective user to a website, where each record includes values for a set of features including user login account, timestamp of attempted login, whether the login was successful, and the like. In one embodiment, the plurality of records of a data table may span across one or more data files. For example, a first subset of records for a data table may be included in a first data file and a second subset of records for the same data table may be included in another second data file.

In one embodiment, a data table may be stored in the data store 270 in conjunction with metadata stored in the metadata store 275. In one instance, the metadata includes transaction logs for data tables. Specifically, a transaction log for a respective data table is a log recording a sequence of transactions that were performed on the data table. A transaction may perform one or more changes to the data table that may include removal, modification, and additions of records and features to the data table, and the like. For example, a transaction may be initiated responsive to a request from a user of the client device 116. As another example, a transaction may be initiated according to policies of the data processing service 102. Thus, a transaction may write one or more changes to data tables stored in the data storage system 110.

In one embodiment, a new version of the data table is committed when changes of a respective transaction are successfully applied to the data table of the data storage system 108. Since a transaction may remove, modify, or add data files to the data table, a particular version of the data table in the transaction log may be defined with respect to the set of data files for the data table. For example, a first transaction may have created a first version of a data table defined by data files A and B each having information for a respective subset of records. A second transaction may have then created a second version of the data table defined by data files A, B and in addition, new data file C that include another respective subset of records (e.g., new records) of the data table.

In one embodiment, the transaction log may record each version of the table, the data files associated with a respective version of the data table, information pertaining to the type of transactions that were performed on the data table, the order in which the transactions were performed (e.g., transaction sequence number, a timestamp of the transaction), and an indication of data files that were subject to the transaction, and the like. In some embodiments, the transaction log may include change data for a transaction that also records the changes for data written into a data table with respect to the previous version of the data table. The change data may be at a relatively high level of granularity, and may indicate the specific changes to individual records with an indication of whether the record was inserted, deleted, or updated due to the corresponding transaction.

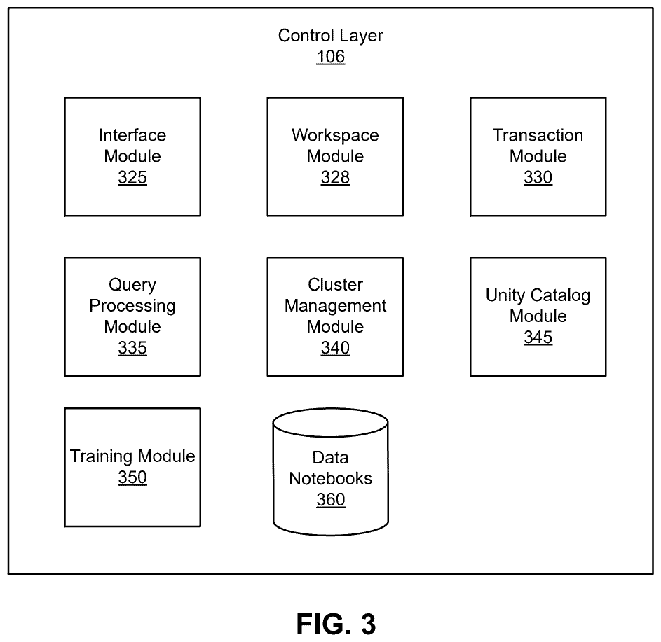

FIG. 3 is a block diagram of an architecture of a control layer 106, in accordance with an embodiment. In one embodiment, the data processing system 106 includes an interface module 325, a transaction module 330, a query processing module 335, a cluster management module 340, and a training module 350. The control layer 106 also includes a data notebook store 360. The modules 325, 330, 335, 340, and 350 may be structured for execution by a computer system, e.g., 800 having some or all of the components as described in FIG. 8, such that the computer system 800 operates in a specified manner as per the described functionality.

The interface module 325 provides an interface and/or a workspace environment where users of client devices 116 (e.g., users associated with tenants) can access resources of the data processing service 102. For example, the user may retrieve information from data tables associated with a tenant, submit data processing requests such as query requests on the data tables, through the interface provided by the interface module 325. The interface provided by the interface module 325 may include notebooks, libraries, experiments, queries submitted by the user. In one embodiment, a user may access the workspace via a user interface (UI), a command line interface (CLI), or through an application programming interface (API) provided by the workspace module 325.

For example, a notebook associated with a workspace environment is a web-based interface to a document that includes runnable code, visualizations, and explanatory text. A user may submit data processing requests on data tables in the form of one or more notebook jobs. The user provides code for executing the one or more jobs and indications such as the desired time for execution, number of cluster worker nodes for the jobs, cluster configurations, a notebook version, input parameters, authentication information, output storage locations, or any other type of indications for executing the jobs. The user may also view or obtain results of executing the jobs via the workspace.

The workspace module 328 deploys workspaces within the data processing service 102. A workspace as defined herein may refer to a deployment in the cloud that functions as an environment for users of the workspace to access assets. An account of the data processing service 102 represents a single entity that can include multiple workspaces. In one embodiment, an account associated with the data processing service 102 may be associated with one workspace. In another embodiment, an account may be associated with multiple workspaces. A workspace organizes objects, such as notebooks, libraries, dashboards, and experiments into folders. A workspace also provides users access to data objects, such as tables or views or functions, and computational resources such as cluster computing systems.

In one embodiment, a user or a group of users may be assigned to work in a workspace. The users assigned to a workspace may have varying degrees of access permissions to assets of the workspace. For example, an administrator of the data processing service 102 may configure access permissions such that users assigned to a respective workspace are able to access all of the assets of the workspace. As another example, users associated with different subgroups may have different levels of access, for example users associated with a first subgroup may be granted access to all data objects while users associated with a second subgroup are granted access to only a select subset of data objects.

The transaction module 330 receives requests to perform one or more transaction operations from users of client devices 116. As described in conjunction in FIG. 2, a request to perform a transaction operation may represent one or more requested changes to a data table. For example, the transaction may be to insert new records into an existing data table, replace existing records in the data table, delete records in the data table. As another example, the transaction may be to rearrange or reorganize the records or the data files of a data table to, for example, improve the speed of operations, such as queries, on the data table. For example, when a particular version of a data table has a significant number of data files composing the data table, some operations may be relatively inefficient. Thus, a transaction operation may be a compaction operation that combines the records included in one or more data files into a single data file.

The query processing module 335 receives and processes queries that access data stored by the data storage system 110. The query processing module 335 may reside in the control layer 106. The queries processed by the query processing module 335 are referred to herein as database queries. The database queries are specified using a declarative database query language such as the SQL. The query processing module 335 compiles a database query specified using the declarative database query language to generate executable code that is executed. The query processing module 335 may encounter runtime errors during execution of a database query and returns information describing the runtime error including an origin of the runtime error representing a position of the runtime error in the database query. In one embodiment, the query processing module 335 provides one or more queries to appropriate clusters of the data layer 108, and receives responses to the queries from clusters in which the queries are executed.

The unity catalog module 345 is a fine-grained governance solution for managing assets within the data processing service 102. It helps simplify security and governance by providing a central place to administer and audit data access. In one embodiment, the unity catalog module 345 maintains a metastore for a respective account. A metastore is a top-level container of objects for the account. The metastore may store data objects and the permissions that govern access to the objects. A metastore for an account can be assigned to one or more workspaces associated with the account. In one embodiment, the unity catalog module 345 organizes data as a three-level namespace, a catalogue is the first layer, a schema (also called a database) is the second layer, and tables and views are the third layer.

In one embodiment, the unity catalog module 345 enables read and write of data to data stored in cloud storage of the data storage system 110 on behalf of users associated with an account and/or workspace. In one instance, the unity catalog module 345 manages storage credentials and external locations. A storage credential represents an authentication and authorization mechanism for accessing data stored on the data storage system 110. Each storage credential may be subject to access-control policies that control which users and groups can access the credential. An external location is an object that combines a cloud storage path (e.g., storage path in the data storage system 110) with a storage credential that authorizes access to the cloud storage path. Each storage location is subject to access-control policies that control which users and groups can access the storage credential. Therefore, if a user does not have access to a storage credential in the unity catalog module 345, the unity catalog module 345 does not attempt to authenticate to the data storage system 110.

In one embodiment, the unity catalog module 345 allows users to share assets of a workspace and/or account with users of other accounts and/or workspaces. For example, users of Company A can configure certain tables owned by Company A that are stored in the data storage system 110 to be shared with users of Company B. Each organization may be associated with separate accounts on the data processing service 102. Specifically, a provider entity can share access to one or more tables of the provider with one or more recipient entities.

Responsive to receiving a request from a provider to share one or more tables (or other data objects), the unity catalog module 345 creates a share in the metastore of the provider. A share is a securable object registered in the metastore for a provider. A share contains tables and notebook files from the provider metastore that the provider would like to share with a recipient. A recipient object is an object that associates an organization with a credential or secure sharing identifier allowing that organization to access one or more shares of the provider. In one embodiment, a provider can define multiple recipients for a given metastore. The unity catalog module 345 in turn may create a provider object in the metastore of the recipient that stores information on the provider and the tables that the provider has shared with the recipient. In this manner, a user associated with a provider entity can securely share tables of the provider entity that are stored in a dedicated cloud storage location in the data storage system 110 with users of a recipient entity by configuring shared access in the metastore.

The training module 350 generates synthetic captions for uncaptioned images of a set of training data. The training module 350 applies a pre-trained I2T model to the uncaptioned images, generating synthetic captions as output. The training module 350 uses the training data to train a T2I model to produce images from text.

The training module 350 obtains a pre-trained I2T model. The pre-trained I2T model is trained to, from an input image, generate a text caption that describes or represents the image. In some embodiments, the pre-trained I2T model may be a BLIP-2 model, pre-trained using a first training dataset. The first training dataset may include captioned images, where each image in the dataset is associated with a caption describing the image. The training module 350 may obtain any other pre-trained image-to-text model. The training module 350 may obtain an open-source model.

The training module 350 obtains a second training dataset to use for training a T2I model. The training module 350 may obtain the second training dataset from the data store 270, where the training data may be uploaded by a user. While the second training dataset may include captioned images that are included in the first training dataset, the second training dataset includes at least training examples obtained from uncaptioned data, in this case, uncaptioned images. In some embodiments, the second training dataset may include training examples with low-quality captions, such as captions that provide basic information about an image but fail to adequately describe or represent the content image. For example, the second training dataset may include images with captions that describe the file type of the image, the date or time the image was taken or uploaded, or image resolution. While these captions do provide information about each image, they fail to describe the content of the image. The second training dataset may be different from the first training dataset used to train the I2T model. The second training dataset may have a lower number of training examples than the first training dataset.

The training module 350 generates synthetic captions for the images of the second training dataset by applying the pre-trained I2T model (e.g., BLIP-2) to the second training dataset. For each image of the second training dataset, the pre-trained I2T model outputs a synthetic caption. The synthetic caption is a text representation of the image of the second training dataset. In some embodiments, the training module 350 may pre-process the second training dataset before applying the pre-trained I2T model. For example, the training module 350 may lower the resolution or resize images to a maximum size (e.g., 512×512 pixels) to reduce the computational cost of applying the pre-trained image-to-text model to the second training dataset. In some embodiments, the training module 350 may receive, from the I2T model, a confidence level associated with each synthetic caption. The training module 350 may filter the second training dataset to exclude training examples where the confidence level of the corresponding synthetic caption does not exceed a threshold confidence level.

The training module 350 may train a T2I model (e.g., SD model) with the second training dataset. The second training dataset includes images paired with synthetic captions generated by the I2T model. The training module 350 trains the T2I model to generate images from text. To train the T2I model, the training module 350 divides the second training dataset into batches of training examples. For each iteration of training, for a batch of the training examples, the training module 350 generates estimations during a forward pass step by applying parameters of the T2I model to tokens representing the synthetic captions. The estimations include reconstructions of image content from the synthetic captions of each training example. For example, for an image of a snail at a birthday party, the synthetic caption may be “snail at a birthday party.” The training module 350 may apply the T2I to “snail at a birthday party” and produce an estimation in the form of an image or a latent representation of an image of a snail eating cake or some rough or coarse representation of a snail. Note that the output of the T2I model, the image of a snail eating cake, is not the same as the training image of a snail at a birthday party but is instead a reconstruction from the text “snail at a birthday party.” The training module 350 computes a loss for the batch of training examples based on the estimations. The loss represents the difference between the estimations and the images of the batch of training examples. To use the same example as above, the loss would be the difference between the image of a snail at a birthday party and the image of a snail eating cake. The training module 350 updates the parameters of the second model to reduce the loss.

FIG. 4 is a block diagram of an architecture of a cluster computing system 402 of the data layer 108, in accordance with an embodiment. In some embodiments, the cluster computing system 402 of the data layer 108 includes driver node 450 and worker pool including multiple executor nodes. The nodes may be structured for execution by a computer system, e.g., 800 having some or all of the components as described in FIG. 8, such that the computer system 800 operates in a specified manner as per the described functionality.

The driver node 450 receives one or more jobs for execution, divides a job into job stages, and provides job stages to executor nodes, receives job stage results from the executor nodes of the worker pool, and assembles job stage results into complete job results, and the like. In one embodiment, the driver node receives a request to execute one or more queries from the query processing module 335. The driver node 450 may compile a database query and generate an execution plan. The driver node 450 distributes the query information including the generated code to the executor nodes. The executor nodes execute the query based on the received information.

The worker pool can include any appropriate number of executor nodes (e.g., 4 executor nodes, 12 executor nodes, 256 executor nodes). Each executor node in the worker pool includes one or more execution engines (not shown) for executing one or more tasks of a job stage. In one embodiment, an execution engine performs single-threaded task execution in which a task is processed using a single thread of the CPU. The executor node distributes one or more tasks for a job stage to the one or more execution engines and provides the results of the execution to the driver node 410. According to an embodiment, an executor node executes the generated code for the database query for a particular subset of data that is processed by the database query. The executor nodes execute the query based on the received information from the driver node 450.

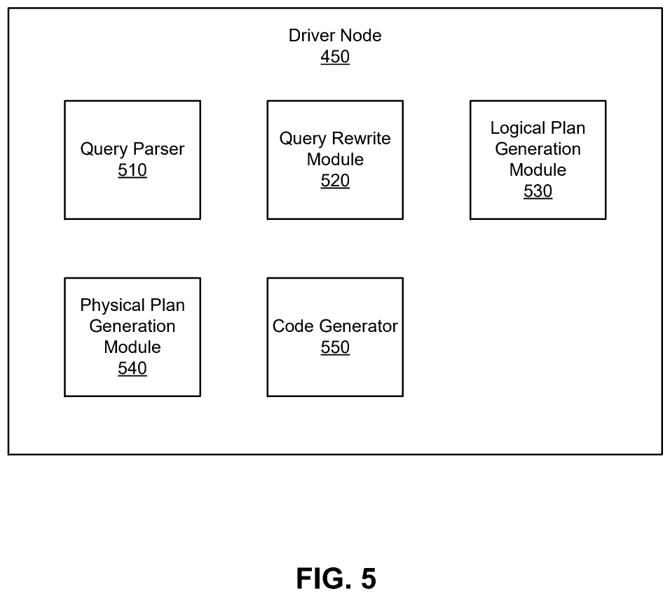

FIG. 5 is a block diagram of an architecture of a driver node 450, in accordance with an embodiment. In one instance, the driver node 450 includes a query parser 510, a query rewrite module 520, a logical plan generation module 530, and a physical plan generation module 540. The modules and nodes may be structured for execution by a computer system, e.g., 800 having some or all of the components as described in FIG. 8, such that the computer system 800 operates in a specified manner as per the described functionality.

The query parser 510 receives a database query for processing and parses the database query. The database query is specified using a declarative database query language such as SQL. The query parser 510 parses the database query to identify various tokens of the database query and build a data structure representation of the database query. The data structure representation identifies various components of the database query, for example, any SELECT expressions that are returned by the database query, tables that are input to the query, a conditional clause of the database query, a group by clause, and so on. According to an embodiment, the data structure representation of the database query is a graph model based on the database query.

The query rewrite module 520 performs transformations of the database query, for example, to improve the execution of the query. The improvement may be in terms of execution time, memory utilization, or other resource utilization. A database query may process one or more tables that store a significant number of records that are processed by the database query. Since the declarative database query language does not specify the procedure for determining the result of the database query, there are various possible procedures for executing the database query.

The query rewrite module 520 may transform the query to change the order of processing of certain steps, for example, by changing the order in which tables are joined, by changing the order in which certain operations such as filtering of records of a table is performed in relation to other operations. The query rewrite module 520 may transform the database query to cause certain temporary results to be materialized. The query rewrite module 520 may eliminate certain operations if the operations are determined to be redundant. The query rewrite module 520 may transform a database query so that certain computations such as subqueries or expressions are shared. The query rewrite module 520 may transform the database query to pushdown certain computations, for example, by changing the order in which certain predicates are applied to the computation as early as possible. The query rewrite module 520 may transform the database query to modify certain predicates to use more optimized versions of the predicates that are computationally equivalent but provide better performance.

The logical plan generation module 530 generates a logical plan for the database query. The logical plan includes representation of the various steps that need to be executed for processing the database query. According to an embodiment, the logical plan generation module 530 generates an unresolved logical plan based on the transformed query graph representation. Various relation names (or table names) and column names may not be resolved in an unresolved logical plan. The logical plan generation module 530 generates a resolved logical plan from the unresolved logical plan by resolving the relation names and column names in the unresolved logical plan. The logical plan generation module 530 further optimizes the resolved logical plan to obtain an optimized logical plan.

The physical plan generation module 540 generates a physical plan from the logical plan generated by the logical plan generation module 530. The physical plan specifies details of how the logical plan is executed by the data processing service 102. The physical plan generation module 540 may generate different physical plans for the same logical plan and evaluate each physical plan using a cost model to select the optimal physical plan for execution. The physical plan further specifies details of various operations of the logical plan. As an example, if the logical plan includes a join operator, the physical plan may specify the type of join that should be performed for implementing the join operator. For example, the physical plan may specify whether the join operator should be implemented as a hash join, merge join, or sort join, and so on. The physical plan may be specific to a database system, whereas the logical plan may be independent of database systems and may be executed on any target database system by converting to a physical plan for that target database system.

The code generator 550 generates code representing executable instructions for implementing the physical plan for executing a database query. The generated code includes a set of instructions for each operator specified in the execution plan. The generated code is specified using a programming language that may be compiled and executed.

### L2H Model Training Example

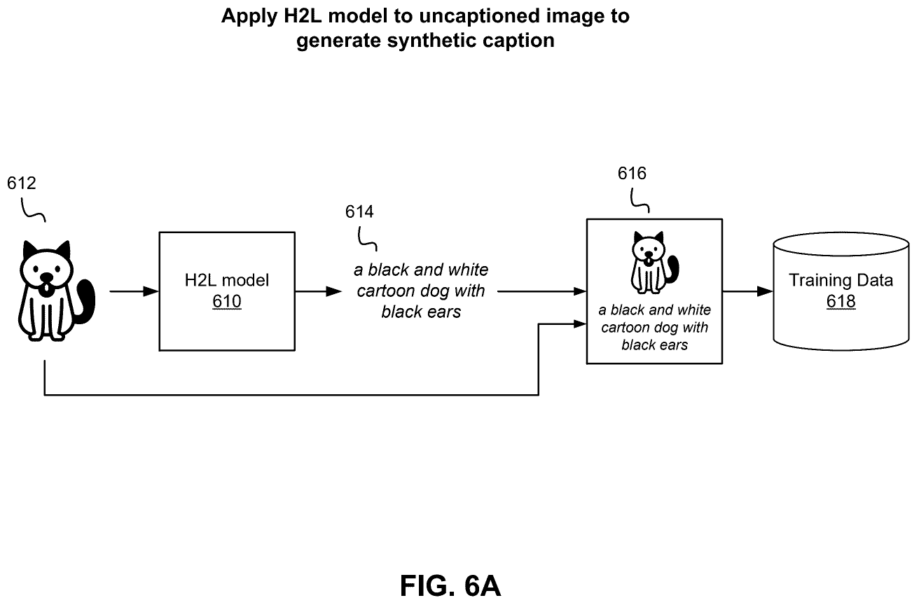

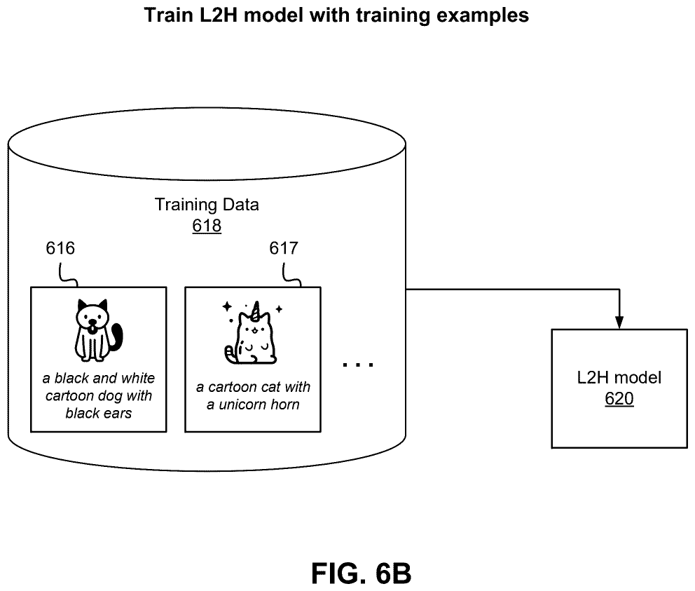

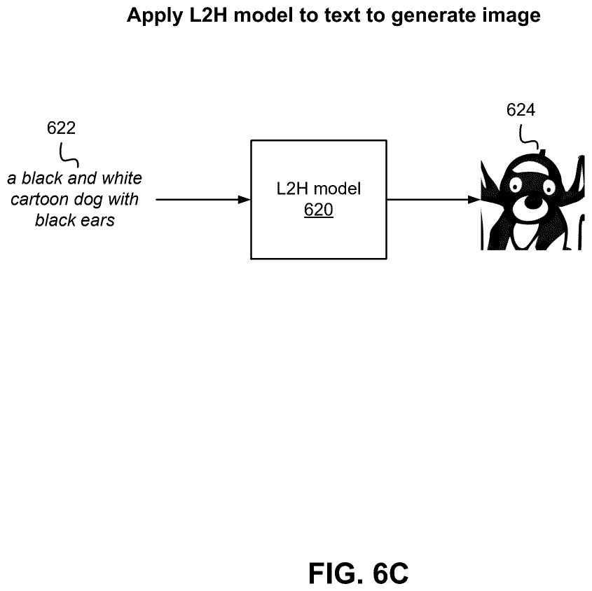

FIGS. 6A-C illustrate an example of training a L2H model by generating synthetic captions for training data, in accordance with an embodiment.

FIG. 6A illustrates a process of applying a H2L model to an uncaptioned training example to generate a synthetic caption, in accordance with an embodiment. In FIG. 6A, the uncaptioned training example 612 is an image of a black and white cartoon dog. A data processing service (e.g., data processing service 102) applies a H2L model 610 to the image 612 and generates, as output, a synthetic caption 614, “a black and white cartoon dog with black ears.” In one embodiment, the H2L model 610 is trained based on first training data. The uncaptioned training example 612 paired with the synthetic caption 614 forms the captioned training example 616, which shows the image of the black and white dog paired with “a black and white cartoon dog with black ears.” Since the model maps a high-dimensional data of an image (including thousands or tens of thousands of pixels or latent pixels) to a low-dimensional data of text, this mapping may be a “lossy compression” in that some nuances and granular information is lost in the generated text. The training example 616 is included in second training data 618.

FIG. 6B illustrates training of a L2H model with training examples of the training data, in accordance with an embodiment. The data processing service trains a L2H model 620 with the second training data 618 that includes training examples 616 and 617. Training example 616 is an image of a black and white dog paired with the synthetic caption “a black and white cartoon dog with black ears,” as seen in FIG. 6A. Training example 617 is an image of a unicorn cat paired with the synthetic caption, “a cartoon cat with a unicorn horn,” which the data processing service may have generated in a process like that shown in FIG. 6A. Further details of training an L2H model like L2H model 620 are described with respect to the training module 350.

FIG. 6C illustrates an inference process of applying a trained L2H model to a text input to generate an image, in accordance with one embodiment. The data processing service applies the L2H model 620, trained on training data 618, to a text input 622, “a black and white cartoon dog with black ears.” The L2H model 620 reconstructs an image from the text input 622, outputting reconstructed image 624, an image of black and white cartoon dog. While the text input 622 is the same as the synthetic caption 614 of training example 616, the reconstructed image 624 is not the same as the image 612 of the training example 616.

### T2I Model Training Process

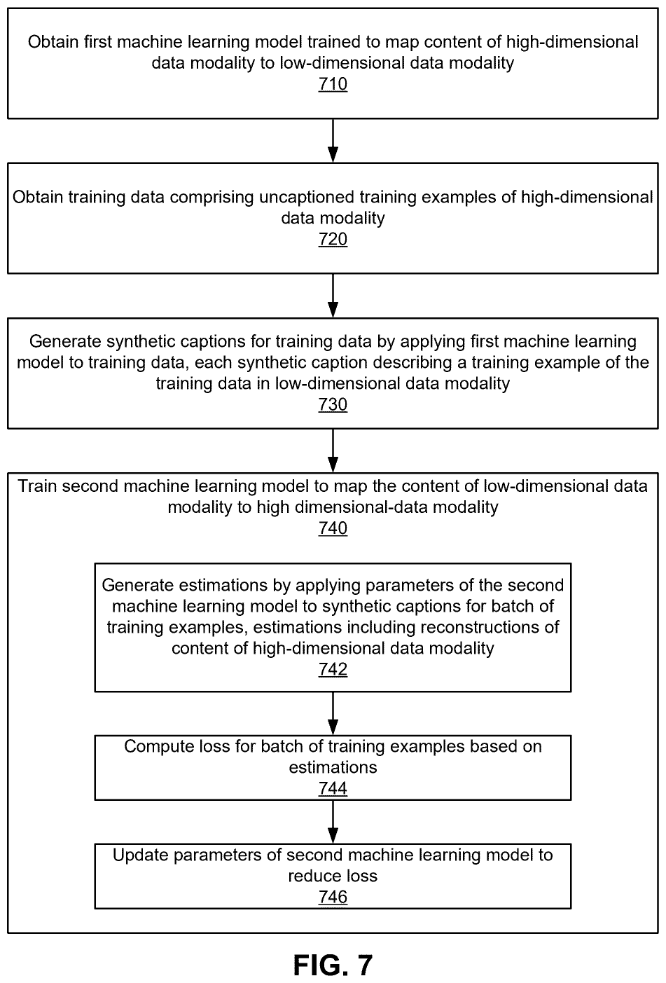

FIG. 7 is a flowchart of a method for training a text-to-image (T2I) model using training data with images and synthetic captions, in accordance with an embodiment. The process shown in FIG. 7 may be performed by one or more components (e.g., the control layer 106) of a data processing system/service (e.g., the data processing service 102). Other entities may perform some or all of the steps in FIG. 7. The data processing service 102 as well as the other entities may include some or of the component of the machine (e.g., computer system) described in conjunction with FIG. 8. Embodiments may include different and/or additional steps, or perform the steps in different orders.

The process starts with the control layer 106 obtaining 710 a first machine learning model. The first machine learning model may be a pre-trained image-to-text (I2T) model trained to map content of a high-dimensional data modality (e.g., images) to a low-dimensional data modality (e.g., text). The control layer 106 obtains 720 a set of training data. The training data includes uncaptioned training examples that are of the high-dimensional data modality (e.g., uncaptioned images). The control layer 106 may obtain the set of training data from data store 270 of the data storage system 110. The control layer 106 generates 730 a set of synthetic captions for the training data by applying the first machine learning model (e.g., I2T model) to the set of training data. Each synthetic caption describes a respective training example (e.g., image) of the set of training data in the low-dimensional data modality (e.g., text). The control layer 106 trains 740 a second machine learning model. The second machine learning model may be a text-to-image (T2I) model trained to map content of the low-dimensional data modality (e.g., text) to the high-dimensional data modality (e.g., images). To train the second machine learning model, the control layer 106 generates 742 a set of estimations by applying a set of parameters of the second machine learning model to the synthetic captions (e.g., text) for a batch of the training examples, wherein the set of estimations include reconstructions of the content of the high-dimensional data modality (e.g., images) for the batch of training examples. The control layer 106 computes 744 a loss for the batch of training examples based on the set of estimations, the loss representing the difference between the estimations and the batch of training examples. The control layer 106 updates 746 the set of parameters of the second machine learning model to reduce the loss.

Turning now to FIG. 8, illustrated is an example machine to read and execute computer readable instructions, in accordance with an embodiment. Specifically, FIG. 8 shows a diagrammatic representation of the data processing service 102 (and/or data processing system) in the example form of a computer system 800. The computer system 800 is structured and configured to operate through one or more other systems (or subsystems) as described herein. The computer system 800 can be used to execute instructions 824 (e.g., program code or software) for causing the machine (or some or all of the components thereof) to perform any one or more of the methodologies (or processes) described herein. In executing the instructions, the computer system 800 operates in a specific manner as per the functionality described. The computer system 800 may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The computer system 800 may be a server computer, a client computer, a personal computer (PC), a tablet PC, a smartphone, an internet of things (IoT) appliance, a network router, switch or bridge, or other machine capable of executing instructions 824 (sequential or otherwise) that enable actions as set forth by the instructions 824. Further, while only a single machine is illustrated, the term “machine” shall also be taken to include any collection of machines that individually or jointly execute instructions 824 to perform any one or more of the methodologies discussed herein.

The example computer system 800 includes a processing system 802. The processor system 802 includes one or more processors. The processor system 802 may include, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The processor system 802 executes an operating system for the computing system 800. The computer system 800 also includes a memory system 804. The memory system 804 may include or more memories (e.g., dynamic random access memory (RAM), static RAM, cache memory). The computer system 800 may include a storage system 816 that includes one or more machine readable storage devices (e.g., magnetic disk drive, optical disk drive, solid state memory disk drive).

The storage unit 816 stores instructions 824 (e.g., software) embodying any one or more of the methodologies or functions described herein. For example, the instructions 824 may include instructions for implementing the functionalities of the transaction module 330 and/or the file management module 335. The instructions 824 may also reside, completely or at least partially, within the memory system 804 or within the processing system 802 (e.g., within a processor cache memory) during execution thereof by the computer system 800, the main memory 804 and the processor system 802 also constituting machine-readable media. The instructions 824 may be transmitted or received over a network 826, such as the network 826, via the network interface device 820.

The storage system 816 should be taken to include a single medium or multiple media (e.g., a centralized or distributed database, or associated caches and servers communicatively coupled through the network interface system 820) able to store the instructions 824. The term “machine-readable medium” shall also be taken to include any medium that is capable of storing instructions 724 for execution by the machine and that cause the machine to perform any one or more of the methodologies disclosed herein. The term “machine-readable medium” includes, but not be limited to, data repositories in the form of solid-state memories, optical media, and magnetic media.

In addition, the computer system 800 can include a display system 810. The display system 810 may driver firmware (or code) to enable rendering on one or more visual devices, e.g., drive a plasma display panel (PDP), a liquid crystal display (LCD), or a projector. The computer system 800 also may include one or more input/output systems 812. The input/output (IO) systems 812 may include input devices (e.g., a keyboard, mouse (or trackpad), a pen (or stylus), microphone) or output devices (e.g., a speaker). The computer system 800 also may include a network interface system 820. The network interface system 820 may include one or more network devices that are configured to communicate with an external network 826. The external network 826 may be a wired (e.g., ethernet) or wireless (e.g., WiFi, BLUETOOTH, near field communication (NFC).

The processor system 802, the memory system 804, the storage system 816, the display system 810, the IO systems 812, and the network interface system 820 are communicatively coupled via a computing bus 808.

### ADDITIONAL CONSIDERATIONS

The foregoing description of the embodiments of the disclosed subject matter have been presented for the purpose of illustration; it is not intended to be exhaustive or to limit the disclosed embodiments to the precise forms disclosed. Persons skilled in the relevant art can appreciate that many modifications and variations are possible in light of the disclosed subject matter.

Some portions of this description describe various embodiments of the disclosed subject matter in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosed subject matter may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the present disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosed embodiments be limited not by this detailed description, but rather by any claims that issue on an application based hereon. Accordingly, the disclosure of the embodiments of the disclosed subject matter is intended to be illustrative, but not limiting, of the scope of the subject matter, which is set forth in the following claims.

What is claimed is:

1. A method, comprising:
obtaining a first machine learning model, the first machine learning model being a pre-trained model trained to map content of a high-dimensional data modality to a low-dimensional data modality, wherein the low-dimensional data modality is a text caption of the content;
obtaining a set of training data, wherein the set of training data comprises at least one or more uncaptioned training examples that are of the high-dimensional data modality;
generating a set of synthetic captions for the training data by applying the first machine learning model to the set of training data, wherein each synthetic caption describes a respective training example of the set of training data in the low-dimensional data modality; and
for one or more iterations, training a second machine learning model, the second machine learning model trained to map content of the low-dimensional data modality to the high-dimensional data modality, by:
generating a set of estimations by applying a set of parameters of the second machine learning model to the synthetic captions for a batch of the training examples, wherein the set of estimations include reconstructions of the content of the high-dimensional data modality for the batch of training examples,
computing a loss for the batch of training examples based on the set of estimations, the loss representing the difference between the estimations and the batch of training examples, and
updating the set of parameters of the second model to reduce the loss.

2. The method of claim 1, wherein the first machine learning model is trained on a different set of training data than the second machine learning model, wherein the different set of training data for the first machine learning model has a higher number of training examples than the set of training data for the second machine learning model.

3. The method of claim 1, wherein the first machine learning model is an image-to-text model and the second machine learning model is a text-to-image model.

4. The method of claim 3, wherein the uncaptioned training examples are images and further comprising pre-processing the images to reduce resolutions of the images before applying the first machine learning model.

5. The method of claim 1, wherein the set of training data comprises both captioned and uncaptioned training examples that are of the high-dimensional data.

6. The method of claim 1, further comprising:
receiving a confidence level associated with each synthetic caption; and
filtering the training data to exclude training examples where the confidence level of the corresponding synthetic caption does not exceed a threshold confidence level.

7. The method of claim 1, wherein the first machine learning model is a pre-trained text-to-image model trained to map content of a low-dimensional data modality to a high-dimensional data modality, wherein the high-dimensional data modality is an image caption of the content, and wherein the second machine learning model is an image-to-text model.

8. A non-transitory computer readable storage medium comprising stored program code, the program code comprising instructions, the instructions when executed causes a processor system to:
obtain a first machine learning model, the first machine learning model being a pre-trained model trained to map content of a high-dimensional data modality to a low-dimensional data modality, wherein the low-dimensional data modality is a text caption of the content;
obtain a set of training data, wherein the set of training data comprises at least one or more uncaptioned training examples that are of the high-dimensional data modality;
generate a set of synthetic captions for the training data by applying the first machine learning model to the set of training data, wherein each synthetic caption describes a respective training example of the set of training data in the low-dimensional data modality; and
for one or more iterations, train a second machine learning model, the second machine learning model trained to map content of the low-dimensional data modality to the high-dimensional data modality, wherein the training of the second machine learning model further comprises instructions to:
generate a set of estimations by applying a set of parameters of the second machine learning model to the synthetic captions for a batch of the training examples, wherein the set of estimations include reconstructions of the content of the high-dimensional data modality for the batch of training examples,
compute a loss for the batch of training examples based on the set of estimations, the loss representing the difference between the estimations and the batch of training examples, and
update the set of parameters of the second model to reduce the loss.

9. The non-transitory computer readable storage medium of claim 8, wherein the first machine learning model is trained on a different set of training data than the second machine learning model, wherein the different set of training data for the first machine learning model has a higher number of training examples than the set of training data for the second machine learning model.

10. The non-transitory computer readable storage medium of claim 8, wherein the first machine learning model is an image-to-text model and the second machine learning model is a text-to-image model.

11. The non-transitory computer readable storage medium of claim 10, wherein the uncaptioned training examples are images and wherein the instructions further comprising instructions that, when executed, cause the processor system to pre-process the images to reduce resolutions of the images before applying the first machine learning model.

12. The non-transitory computer readable storage medium of claim 8, wherein the set of training data comprises both captioned and uncaptioned training examples that are of the high-dimensional data.

13. The non-transitory computer readable storage medium of claim 8, wherein the instructions further comprise instructions that, when executed, cause the processor system to:
receive a confidence level associated with each synthetic caption; and
filter the training data to exclude training examples where the confidence level of the corresponding synthetic caption does not exceed a threshold confidence level.

14. The non-transitory computer readable storage medium of claim 8, wherein the first machine learning model is a pre-trained text-to-image model trained to map content of a low-dimensional data modality to a high-dimensional data modality, wherein the high-dimensional data modality is an image caption of the content, and wherein the second machine learning model is an image-to-text model.

15. A computer system, comprising:
a computer processor; and
a non-transitory computer readable storage medium comprising stored program code, the program code comprising instructions, the instructions when executed causes a processor system to:
obtain a first machine learning model, the first machine learning model being a pre-trained model trained to map content of a high-dimensional data modality to a low-dimensional data modality, wherein the low-dimensional data modality is a text caption of the content;
obtain a set of training data, wherein the set of training data comprises at least one or more uncaptioned training examples that are of the high-dimensional data modality;
generate a set of synthetic captions for the training data by applying the first machine learning model to the set of training data, wherein each synthetic caption describes a respective training example of the set of training data in the low-dimensional data modality; and
for one or more iterations, train a second machine learning model, the second machine learning model trained to map content of the low-dimensional data modality to the high-dimensional data modality, wherein the training of the second machine learning model further comprises instructions to:
generate a set of estimations by applying a set of parameters of the second machine learning model to the synthetic captions for a batch of the training examples, wherein the set of estimations include reconstructions of the content of the high-dimensional data modality for the batch of training examples,
compute a loss for the batch of training examples based on the set of estimations, the loss representing the difference between the estimations and the batch of training examples, and
update the set of parameters of the second model to reduce the loss.

16. The computer system of claim 15, wherein the first machine learning model is trained on a different set of training data than the second machine learning model, wherein the different set of training data for the first machine learning model has a higher number of training examples than the set of training data for the second machine learning model.

17. The computer system of claim 15, wherein the first machine learning model is an image-to-text model and the second machine learning model is a text-to-image model.

18. The computer system of claim 17, wherein the uncaptioned training examples are images and wherein the instructions further comprising instructions that, when executed, cause the processor system to pre-process the images to reduce resolutions of the images before applying the first machine learning model.

19. The computer system of claim 15, wherein the set of training data comprises both captioned and uncaptioned training examples that are of the high-dimensional data.

20. The computer system of claim 15, wherein the instructions further comprise instructions that, when executed, cause the processor system to:
receive a confidence level associated with each synthetic caption; and
filter the training data to exclude training examples where the confidence level of the corresponding synthetic caption does not exceed a threshold confidence level.
